(19) United States
(12) Patent Application Publication
(10) Pub. No.: US 2011/0128940 A1
(43) Pub. Date: Jun. 2, 2011

(54) TIMESLOT CONVERSION IN A CELLULAR COMMUNICATION SYSTEM

(75) Inventors: Walter Featherstone, Swindon (GB); Howard J. Thomas, Cirencester (GB)

(73) Assignee: MOTOROLA, INC., Schaumburg, IL (US)

(21) Appl. No.: 11/995,148

(22) PCT Filed: Jun. 23, 2006
(86) PCT No.: PCT/US06/24444

§ 371 Date: Dec. 1, 2009

(30) Foreign Application Priority Data
Sep. 2, 2005 (GB) 0517897.5

(51) Int. Cl. H04W 72/04

(52) U.S. Cl. 370/336

(57) ABSTRACT

A cellular communication system employs an air interface time frame structure comprising time frames divided into a plurality of timeslots. In the system, a timeslot configuration processor (115) comprises a timeslot configurator (203) which configures timeslots of the time frames as a first service type or a second service type. The first and second service type can be circuit switched or packet switched service types. A first processor (205) converting a first timeslot from the first service type to the second service type. The cellular communication system then supports at least one service of the second service type in the first timeslot. A second processor (207) converts the first timeslot from the second type to the first type in response to a first service type usage characteristic for a cell supporting the at least one service and a second service type usage characteristic for a plurality of cells. The invention can improve timeslot conversion performance and can specifically reduce the required number of timeslot conversions.

### FIELD OF THE INVENTION

The invention relates to time slot conversion in a cellular communication system and in particular to time slot conversion between different service types.

### BACKGROUND OF THE INVENTION

In a cellular communication system a geographical region is divided into a number of cells each of which is served by a base station. The base stations are interconnected by a fixed network which can communicate data between the base stations. A mobile station is served via a radio communication link by the base station of the cell within which the mobile station is situated.

As a mobile station moves, it may move from the coverage of one base station to the coverage of another, i.e. from one cell to another. As the mobile station moves towards a base station, it enters a region of overlapping coverage of two base stations and within this overlap region it changes to be supported by the new base station. As the mobile station moves further into the new cell, it continues to be supported by the new base station. This is known as a handover or handoff of a mobile station between cells.

A typical cellular communication system extends coverage over typically an entire country and comprises hundreds or even thousands of cells supporting thousands or even millions of mobile stations. Communication from a mobile station to a base station is known as uplink, and communication from a base station to a mobile station is known as downlink.

The fixed network interconnecting the base stations is operable to route data between any two base stations, thereby enabling a mobile station in a cell to communicate with a mobile station in any other cell. In addition, the fixed network comprises gateway functions for interconnecting to external networks such as the Public Switched Telephone Network (PSTN), thereby allowing mobile stations to communicate with landline telephones and other communication terminals connected by a landline. Furthermore, the fixed network comprises much of the functionality required for managing a conventional cellular communication network including functionality for routing data, admission control, resource allocation, subscriber billing, mobile station authentication etc.

Currently, the most ubiquitous cellular communication system is the 2nd generation communication system known as the Global System for Mobile communication (GSM). Further description of the GSM TDMA communication system can be found in ‘The GSM System for Mobile Communications’ by Michel Mouly and Marie Bernadette Pautet, Bay Foreign Language Books, 1992, ISBN 2950719007.

3rd generation systems are currently being rolled out to further enhance the communication services provided to mobile users. One such system is the Universal Mobile Telecommunication System (UMTS), which is currently being deployed. Further description of CDMA and specifically of the Wideband CDMA (WCDMA) mode of UMTS can be found in ‘WCDMA for UMTS’, Harri Holma (editor), Antti Toskala (Editor), Wiley & Sons, 2001, ISBN 0471486876.

To further enhance the services and performance of the GSM communication system, a number of enhancements and additions have been introduced to the GSM communication system over the years.

One such enhancement is the General Packet Radio System (GPRS), which is a system developed for enabling packet data based communication in a GSM communication system. Thus, the GPRS system is compatible with the GSM (voice) system and provides a number of additional services including provision of packet data communication, which augments and complements the circuit switched communication of a traditional communication system. Furthermore, the packet based data communication may also support packet based speech services. The GPRS system has been standardised as an add-on to an existing GSM communication system, and can be introduced to an existing GSM communication system by introducing new network elements. Specifically, a number of Serving GPRS Support Nodes (SGSN) and Gateway GPRS Support Nodes (GGSN) may be introduced to provide a packet based fixed network communication.

In a GSM/GPRS TDMA network, air interface timeslots are either configured to support circuit switched or packet switched sessions. A timeslot supporting a circuit switched user session is configured as a Traffic CHannel (TCH) and a timeslot supporting a packet switched user session is configured as a Packet Data CHannel (PDCH). The packet switched timeslots and the circuit switched timeslots are generally considered to belong to different domains which are controlled by different entities. For example, the circuit switched timeslots can be controlled by a cell resource manager located in the base stations whereas the packet switched timeslots are controlled by a packet resource manager located at a packet control unit which is typically coupled directly to a Base Station Controller (BSC) (or is part of the BSC). The packet control unit is typically common for a plurality of base stations.

There are cases when it is desirable to convert a timeslot configured for circuit switched services to be a timeslot configured for packet switched services, or vice versa.

For example, a service known as Dual Transfer Mode (DTM) has been standardized for GSM/GPRS systems. In DTM, a single mobile station is allocated a simultaneous circuit switched and packet switched session. For example, the mobile station may support a conventional voice communication at the same time as an Internet browsing application.

A requirement of the timeslot allocations for DTM is that the mobile station is provided with a circuit switched timeslot and a packet switched timeslot which are on the same carrier and are adjacent to each other. This restriction facilitates receiver and transmitter design. However, without the ability to convert timeslots from one domain to the other, the number of locations DTM users can be placed is extremely restricted.

However, timeslot conversion has a number of disadvantages. For example, conversion of timeslots may typically require that an existing circuit switched call is moved through an intra cell handover, which is undesirable as it may result in a reduced perceived voice quality. Furthermore, signaling is required between the cell resource manager and the packet resource manager to effect the conversion and to maintain synchronization between the two entities. This takes time and requires additional processing and communication resources. Also, the actual physical conversion is not instantaneous and results in a short time interval during which the timeslot cannot be used for any service. This results in a reduced overall system capacity.

Typically, the converted timeslot is converted back to the original type following the termination of the service(s) requiring the conversion. For example, a packet switched timeslot may be used by a plurality of different mobile stations, and when the last mobile station utilizing the packet switched timeslot terminates the service, the timeslot is unused and is accordingly converted back to being a circuit switched timeslot.

Accordingly, a large number of conversions may take place during normal operation leading to reduced performance, reduced capacity and increased resource consumption.

Hence, an improved system would be advantageous and in particular timeslot conversion allowing increased flexibility, improved resource utilisation, a reduced number of conversions, improved adaptation to current conditions, an improved user experience, reduced complexity and/or improved performance would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided an apparatus for a cellular communication system employing an air interface time frame structure comprising time frames divided into a plurality of timeslots; the apparatus comprising: means for configuring timeslots of the time frames as a first service type or a second service type; first conversion means for converting a first timeslot from the first service type to the second service type; means for supporting at least one service of the second service type in the first timeslot; and second conversion means for converting the first timeslot from the second type to the first type in response to a first service type usage characteristic for a cell supporting the at least one service and a second service type usage characteristic for a plurality of cells.

The invention can allow improved performance and operation of a cellular communication system. An improved control and management of the allocation and configuration of timeslots can be achieved. In particular, improved conversion performance of timeslots can be achieved. The inventors of the current invention have realised that an improved performance can be achieved by making e.g. a temporary conversion between service type configurations for a timeslot depending on both a local and global service type usage characteristic where the local service type usage characteristic relates to the cell supporting the at least one service and the global service cell relates to a group of cells. For example, the group of cells may relate to a group of cells for which resource is commonly controlled and/or for which a common combined resource restriction applies. The resource commonly controlled may be a communication or processing resource for the first service type or for the second service type. For example, a timeslot can be maintained as the second service type if the local first service type usage characteristic indicates that there is a high likelihood of this being used for another service of the second service type and the global second service type usage characteristic indicates that the resource is not required for a second service type time slot in another cell. Thus, performance can be optimised taking into account both local and global conditions. In particular, the invention can allow a reduced number of timeslot service type conversions to be performed thereby resulting in reduced delays, improved resource utilisation and/or facilitated operation. The term global is herein used to refer to a group of cells and the term local is used to refer to a single cell.

A service type usage characteristic can be a characteristic which indicates a measure of the current or past level of usage for the service type or can be a likelihood of a future usage level for the service type.

According to an optional feature of the invention, the first service type and the second service type are different service types from the group consisting of a packet switched service type and a circuit switched type.

An improved conversion performance between packet switched timeslots and circuit switched timeslots can be achieved. The invention can allow a more flexible system and resource allocation while maintaining a low overhead resulting from timeslot conversions. A packet switched service type timeslot is a timeslot configured to support packet switched communication over the air interface. A circuit switched service type timeslot is a timeslot configured to support circuit switched communication over the air interface.

The invention may for example be suitable for a Dual Transfer Mode communication in a GSM cellular communication system. A timeslot can temporarily be converted from a circuit switched timeslot to a packet switched timeslot (or vice versa) to support one are more DTM services. The conversion back to a circuit switched timeslot (or to the packet switched timeslot) can be made dependent on local and global service type usage characteristics thereby reflecting conditions and restrictions for the serving cell and a plurality of other cells.

According to an optional feature of the invention, the first service type is the packet switched service type and the second service type is the circuit switched service type.

The invention can allow an improved temporary conversion of a packet switched timeslot to a circuit switched timeslot. Specifically the conversion back to a packet switched timeslot can be dependent on a local and global service type usage characteristic.

According to an optional feature of the invention, wherein the first service type is the circuit switched service type and the second service type is the packet switched service type.

The invention can allow an improved temporary conversion of a circuit switched timeslot to a packet switched timeslot. Specifically the conversion back to a circuit switched timeslot can be dependent on a local and global service type usage characteristic.

According to an optional feature of the invention, at least one of the first service type usage characteristic and the second service type usage characteristic comprises a packet switched service loading characteristic.

This can allow improved performance and or facilitated implementation. For example, for a DTM service, a circuit switched timeslot can temporarily be converted to a packet switched timeslot and can only be converted back to a circuit switched timeslot if the packet switched service loading is sufficiently low in the serving cell or sufficiently high in the group of cells.

According to an optional feature of the invention, at least one of the first service type usage characteristic and the second service type usage characteristic comprises a circuit switched service loading characteristic.

This can allow improved performance and or facilitated implementation. For example, for a DTM service a packet switched timeslot can temporarily be converted to a circuit switched timeslot and can only be converted back to a packet switched timeslot if the circuit switched service loading is sufficiently low in the serving cell or sufficiently high in the group of cells.

According to an optional feature of the invention, at least one of the first service type usage characteristic and the second service type usage characteristic comprises a congestion characteristic for a serving cell for the at least one service.

This can allow improved performance and/or facilitated implementation. In particular, the conversion performance can be optimised for the current conditions of the serving cell.

According to an optional feature of the invention, at least one of the first service type usage characteristic and the second service type usage characteristic comprises a congestion characteristic for a plurality of cells for the at least one service.

The plurality of cells may be the group of cells. This can allow improved performance and/or facilitated implementation. In particular, the conversion performance can be optimised for the current conditions for a group of cells.

According to an optional feature of the invention, the plurality of cells consists in a group of cells associated with a timeslot allocator used for allocation of timeslots for the at least one service.

This can allow improved performance and/or facilitated implementation. The timeslot allocator may for example be a packet control unit controlling the packet operation for the group of cells. Thus, conversion performance can be optimised for the current conditions in all cells that are controlled together while taking into account the conditions of the specific cell supporting the at least one service.

According to an optional feature of the invention, the cellular communication system is arranged to support a combined service comprising a first sub-service utilizing a timeslot of the first service type and a second sub-service utilizing a timeslot of the second service type and wherein the at least one service is the second sub-service.

This can allow improved performance and or facilitated implementation. For example, the combined service can be a DTM service comprising a first sub-service being a packet switched or circuit switched service and a second sub-service being the complementary type service.

Specifically, the combined service can be a DTM service comprising a packet switched sub-service and a circuit switched sub-service.

According to an optional feature of the invention, the at least one of the first service type usage characteristic and the second service type usage characteristic comprises a loading of a communication service not being a sub-service of the combined service.

This can allow improved performance. For example, conversion performance can be optimized taking into account not only the conditions and characteristics of the service supported by the conversion, but also taking into account the characteristics and conditions of other services. As the other services can affect the resource requirements for timeslots of different service types this can allow improved resource allocation of timeslots.

According to an optional feature of the invention, the first service type and the second service type are different service types from the group consisting of: a packet switched data service type; a packet switched voice service type; a packet switched broadcast service type; a circuit switched data service type; and a circuit switched voice service type.

The invention can allow improved time slot conversion for a number of different service types and can in particular improve and/or facilitate co-existence of different service types. Specifically, the invention can allow improved co-existence and resource sharing for DTM services, MBMS services and GPRS services of a GSM cellular communication system.

According to an optional feature of the invention, a resource for the first service type and a resource for the second service type are controlled by different resource controllers.

The different resource controllers may be different entities of the cellular communication system and/or may be at different hierarchical layers of the cellular communication system. For example, one service type may be managed in the base stations and one service type may be managed in base station controllers. One resource controller may control operation in a single cell whereas another of the resource controllers may control operation in the group of cells. For example, one resource controller can be a Cell Resource Manager (CRM) and the other can be a Packet Control Unit (PCU) of a GSM cellular communication system.

The feature can allow improved performance and interoperability in systems comprising different resource controllers.

According to an optional feature of the invention, the group of cells have a common resource restriction.

The common resource restriction may for example be a shared communication and/or processing resource. The feature can allow improved performance.

In some embodiments, the first conversion means is arranged to convert the first timeslot from the first service type to the second service type in response to a setup of the at least one service.

This can allow improved performance and/or facilitated operation. In particular, it can allow an effective temporary conversion to be performed when needed.

In some embodiments, the second conversion means is further arranged to convert the first timeslot from the second service type to the first service type in response to a termination of the at least one service. This can allow improved performance.

In some embodiments, the second conversion means is further arranged to convert the first timeslot from the second service type to the first service type in response to a determination that no services of the second service type is active in the first timeslot.

This can allow improved performance. For example, a packet switched timeslot can be used by a plurality of packet switched services. When the last of these services cease to use the timeslot, the timeslot can be converted back to being a circuit switched timeslot.

According to an optional feature of the invention, the second conversion means is arranged to convert the first timeslot from the second type to the first type if the first service type usage characteristic and the second service type usage characteristic meet a criterion and not to convert the first timeslot otherwise.

This can allow improved performance, facilitated operation and/or facilitated implementation.

According to an optional feature of the invention, the cellular communication system is a Global System for Mobile communication (GSM) cellular communication system.

The invention can allow improved performance in a GSM cellular communication system. In particular, the invention can allow improved conversion between circuit switched timeslots and packet switched timeslots. The invention can improve resource utilization and an increased capacity of the cellular communication system as a whole. An improved user experience and quality of service can be provided.

According to an optional feature of the invention, the at least one service is a packet switched service or a circuit switched service of a Dual Transfer Mode (DTM) service.

The invention can allow improved performance for a DTM service in a GSM cellular communication system.

According to an optional feature of the invention, at least one of the first service type usage characteristic and the second service type usage characteristic comprises a loading of DTM services.

This can allow improved performance and can in particular allow an improved flexibility and efficient support of DTM services. The loading of DTM services can be a DTM loading across the system, a group of cells, or a serving cell.

According to another aspect of the invention, there is provided a cellular communication system employing an air interface time frame structure comprising time frames divided into a plurality of timeslots; the cellular communication system comprising: means for configuring timeslots of the time frames as a first service type or a second service type; first conversion means for converting a first timeslot from the first service type to the second service type; means for supporting at least one service of the second service type in the first timeslot; and second conversion means for converting the first timeslot from the second type to the first type in response to a first service type usage characteristic for a cell supporting the at least one service and a second service type usage characteristic for a plurality of cells.

According to another aspect of the invention, there is provided a method of operation in a cellular communication system employing an air interface time frame structure comprising time frames divided into a plurality of timeslots; the method comprising: configuring timeslots of the time frames as a first service type or a second service type; converting a first timeslot from the first service type to the second service type; supporting at least one service of the second service type in the first timeslot; and converting the first timeslot from the second type to the first type in response to a first service type usage characteristic for a cell supporting the at least one service and a second service type usage characteristic for a plurality of cells.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a cellular communication system in accordance with some embodiments of the invention;

FIG. 2 illustrates a timeslot configuration processor in accordance with some embodiments of the invention; and

FIG. 3 illustrates an exemplary method of operation for the cellular communication system of FIG. 1.

### DETAILED DESCRIPTION OF SOME EMBODIMENTS OF THE INVENTION

The following description focuses on embodiments of the invention applicable to a GSM cellular communication system and in particular to a GSM cellular communication system supporting DTM services. However, it will be appreciated that the invention is not limited to this application but may be applied to many other cellular communication systems and services.

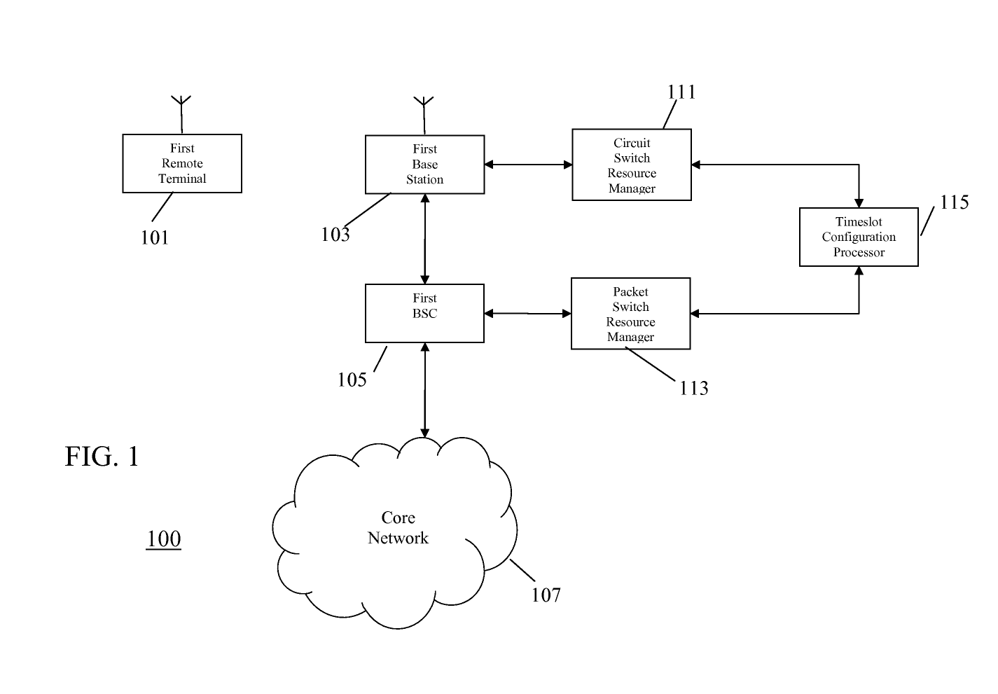

FIG. 1 illustrates an example of a cellular communication system 100 in accordance with some embodiments of the invention.

In the example of FIG. 1, a first remote terminal 101 is in a first cell supported by a first base station 103. The remote terminal 101 can be a user equipment such as a 3rd Generation User Equipment (UE), a communication unit, a subscriber unit, a mobile station, a communication terminal, a personal digital assistant, a laptop computer, an embedded communication processor or any physical, functional or logical communication element which is capable of communicating over the air interface of the cellular communication system.

It will be appreciated, that for brevity and clarity, FIG. 1 illustrates only the elements of the cellular communication system required for the following description. As will be will known to the skilled person, practical cellular communication systems typically comprise a large number of base stations supporting a large number of remote terminals.

The first base station 103 is coupled to a first Base Station Controller (BSC) 105. A BSC performs many of the control functions related to the air interface including radio resource management and routing of data to and from appropriate base stations.

The first BSC 105 is coupled to a core network 107. A core network interconnects BSCs and is operable to route data between any two BSCs, thereby enabling a remote terminal in a cell to communicate with a remote terminal in any other cell. In addition, a core network comprises gateway functions for interconnecting to external networks such as the Public Switched Telephone Network (PSTN), thereby allowing remote terminals to communicate with landline telephones and other communication terminals connected by a landline. Furthermore, the core network comprises much of the functionality required for managing a conventional cellular communication network including functionality for routing data, admission control, resource allocation, subscriber billing, remote terminal authentication etc. The core network can specifically comprise one or more Mobile Switching Centres (MSCs).

In the example of FIG. 1, the first remote terminal 101 is a remote terminal capable of supporting a DTM service. Likewise, the first base station 103 and the fixed network as a whole are capable of supporting a DTM service. Thus, the cellular communication system supports both circuit switched and packet switched communication over the air interface. In particular, when the remote terminal 101 is operating a DTM service, it is actively communicating using two adjacent timeslots of the GSM TDMA frame. One of the timeslots is used the circuit switched communication and the other timeslot is used for the packet switched communication.

Thus, a DTM service is a combined service wherein the cellular communication system supports both a packet switch sub-service and a circuit switched sub-service.

In order to manage the circuit switched communications over the air interface, the cellular communication system comprises a circuit switch resource manager 111. In the example, the circuit switch resource manager 111 is coupled to the first base station 103 and is specifically arranged to control the circuit switched communication for the first base station 103.

Similarly, in order to manage the packet switched communications, the cellular communication system comprises at packet switch resource manager 113. In the example, the packet switch resource manager 113 is coupled to the first BSC 105 and is arranged to control the packet switched communication for the base stations supported by the BSC 105.

Thus, in this setup the circuit switched communication and the packet switched communication is controlled by different entities of the fixed network. Furthermore, the control of the packet switched communication and the circuit switched communication is performed at different levels of the hierarchy of the fixed network. In the example, the circuit switch resource manager 111 is arranged to control the resource allocation for the timeslots which are configured for circuit switched communications and the packet switch resource manager 113 is arranged to control the resource allocation for the timeslots which are configured for packet switch communications.

The packet switch resource manager 113 manages the packet switched resources in a group of cells, namely the group of cells supported by the first BSC 105. The packet switch resource manager 113 furthermore controls these subject to a common combined resource restriction. In the example, the number of simultaneous DTM services that can be supported is restricted by a restriction on the number of simultaneous DTM packet switched communications in the group of cells. Such a restriction can for example be imposed by a processing resource limitation.

In the GSM system of FIG. 1, some timeslots of the TDMA frame are configured as circuit switched timeslots used to support circuit switched communications, and some timeslots are configured as packet switched timeslots used to support packet switched communications.

In order to achieve an efficient resource utilisation, it is important that timeslots are configured in a way that suits the current conditions. However, as conditions may change, it is desirable for the configuration to be adaptable. For example, when setting up a DTM service, it is necessary for a packet switched timeslot to be allocated adjacent to the circuit switched timeslot. In order to achieve this, it may often be advantageous to temporarily convert a timeslot from one domain to the other.

The cellular communication system of FIG. 1 comprises a timeslot configuration processor 115 which controls the configuration of timeslots as either circuit switched timeslots or packet switched timeslots. Furthermore, the timeslot configuration processor 115 is specifically capable of converting a timeslot configuration from one domain to the other. The timeslot configuration processor 115 is coupled to the circuit switch resource manager 111 and the packet switch resource manager 113 and can provide timeslot configuration information to these. Specifically, when a timeslot is reconfigured from being a packet switched timeslot to a circuit switched timeslot (or vice versa) the circuit switch resource manager 111 and the packet switch resource manager 113 are informed of the reconfigured timeslots.

It will be appreciated, that for clarity FIG. 1 shows the timeslot configuration processor 115 as being directly coupled to the circuit switch resource manager 111 and the packet switch resource manager 113. However, in practical systems the timeslot configuration information can typically be communicated through communication links between the GSM elements, such as between the first base station 103 and the BSC 105.

Although the timeslot configuration processor 115 is capable of dynamically converting timeslots from one domain to the other in order to adapt to the current conditions and requirements, the conversion result in additional signalling in the fixed network, increased inconvenience to other users(for example because an intra-cell handover of another remote terminal can be necessary) and increased processing complexity. Therefore, it is desirable to optimise the conversion of timeslots between the packet switched and the circuit switched domain.

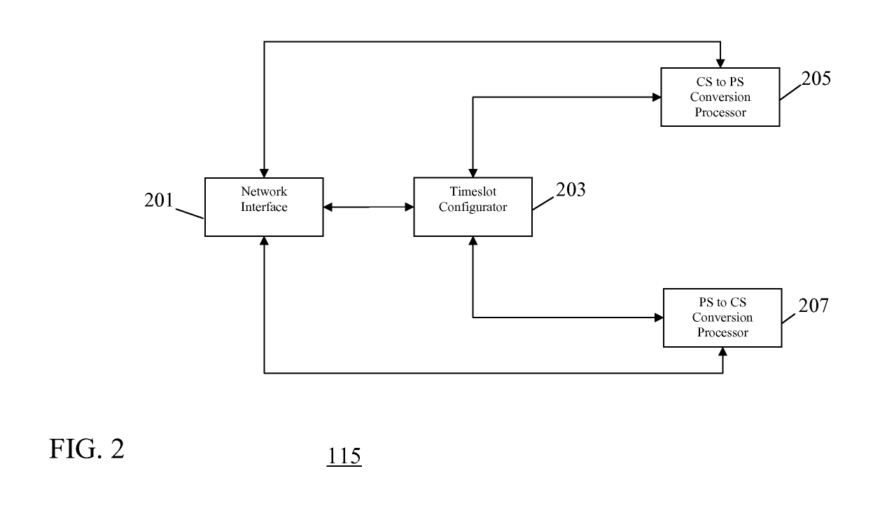

FIG. 2 illustrates the timeslot configuration processor 115 in more detail.

The timeslot configuration processor 115 comprises a network interface 201. The network interface 201 is capable of interfacing with the fixed network in order to receive and transmit messages and signalling. Specifically the network interface 201 can communicate with the circuit switch resource manager 111 and packet switch resource manager 113 to provide configuration information and receive resource allocation and admission request information.

The network interface 201 is coupled to a timeslot configurator 203 which configures the timeslots as either packet switched timeslot or circuit switched timeslot. The network interface 201 and timeslot configurator 203 are furthermore coupled to a circuit-switched-to-packet-switched (CS-to-PS) conversion processor 205 and a packet-switched-to-circuit-switched (PS-to-CS) conversion processor 207. The CS-to-PS conversion processor 205 is arranged to determine that the conversion of a timeslot from a circuit switched timeslot to a packet switched timeslot is required. If so, the CS-to-PS conversion processor 205 causes the timeslot conversion by sending the appropriate control signals to the timeslot configurator 203. Similarly, the PS-to-CS conversion processor 207 is arranged to determine that the conversion of a timeslot from a packet switched timeslot to a circuit switched timeslot is required. If so the PS-to-CS conversion processor 207 causes the timeslot conversion by sending the appropriate control signals to the timeslot configurator 203.

In operation, the remote terminal 101 can request that a DTM service is set up. Accordingly, a resource request for a circuit switched timeslot is sent to the circuit switch resource manager 111 and a resource request for a packet switched timeslot is sent to the packet switch resource manager 113. The resource requests furthermore comprise the restriction that the timeslots must be adjacent. Accordingly the circuit switch resource manager 111 and the packet switch resource manager 113 seek to allocate timeslots that meets the requirements. However, if this is not possible, it is evaluated if the requirements can be met if a timeslot is converted from one domain to the other.

For example, when the DTM service is initialised, the circuit switch resource manager 111 can identify a number of unused circuit switched timeslots and can send information of these to the packet switch resource manager 113. Accordingly the packet switch resource manager 113 can attempt to allocate a timeslot adjacent to any of the unused circuit switched timeslots. If this is not possible, the circuit switch resource manager 111 is informed of the failure to allocate a packet switched timeslot. Consequently the circuit switch resource manager 111 can select two adjacent circuit switched timeslots and send a request to the timeslot configuration processor 115 that one of these is converted to the packet switch domain.

The request can be received by the network interface 201 which forwards it to the CS-to-PS conversion processor 205. The CS-to-PS conversion processor 205 evaluates the feasibility and desirability of converting the timeslot from the circuit switched domain to the packet switched domain. If this evaluation is positive, the processor 205 controls the timeslot configurator 203 to reconfigure the timeslot as a packet switched timeslot. The information of the reconfiguration is forwarded to the circuit switch resource manager 111 and the packet switch resource manager 113 which accordingly proceed to allocate the selected timeslots to the remote terminal 101 in support of the DTM service.

When the remote terminal 101 terminates the DTM service, the circuit switch resource manager 111 and the packet switch resource manager 113 release the resource allocation of the used packet and circuit switched timeslots. If no other packet services are using the packet switched timeslot, the packet switch resource manager 113 informs the timeslot configuration processor 115 that the timeslot is no longer used for packet switched services. When receiving this information, the network interface 201 forwards it to the PS-to-CS conversion processor 207. The PS-to-CS conversion processor 207 then proceeds to evaluate if the timeslot should be converted back to being a circuit switched timeslot.

However, in accordance with some embodiments of the invention, the PS-to-CS conversion processor 207 does not necessarily proceed to convert the packet switched timeslot back to a time switch timeslot simply because it is no longer used by the packet switch service(s). Rather, in the example of FIG. 1, the PS-to-CS conversion processor 207 evaluates service type usage characteristics for both the cell supporting the DTM service as well as for the cells supported by the packet switch resource manager 113. This evaluation is used to determine if the timeslot should be converted back to the circuit switched domain. Thus, in the example, the conversion of timeslots is not merely based on the conditions, operation or performance of the individual remote terminal or the individual cell. Rather, the conversion depends on the service usage in the cell as well as in other cells which are managed by a common resource controller. This can allow improved performance and in particular, an improved conversion performance resulting in increased resource utilisation, increased flexibility, lower signalling requirements and reduced complexity.

In the specific example, the timeslot configuration processor 115 evaluates if the service type usage characteristics meet a criterion. If so, the timeslot is converted back to the original domain and otherwise the timeslot is maintained configured for the new domain.

For example, one or both of the service type usage characteristics can be a loading of packet switched services. If the loading is high in the serving cell, indicating that there is a high likelihood that a packet switched timeslot will be needed in the cell, and the loading is low in the group of cells, indicating that there is a high likelihood that a packet switched timeslot will be needed in the other cells of the group, the PS-to-CS conversion processor 207 will not convert the timeslot back to the circuit switched domain but will maintain it in its current form as a packet switched timeslot. Specifically, the PS-to-CS conversion processor 207 can compare the packet switched loading of the cell to a threshold which is determined in response to the packet switched loading in other cells, and only if the loading is below the threshold will the packet switched timeslot be converted back to a circuit switched timeslot. This can improve performance as a packet switched timeslot will remain as a packet switched timeslot if it is likely that further services in the cell may require it. In particular the approach can prevent that a packet switched timeslot is converted back to a circuit switched timeslot at the end of a DTM service, followed by the circuit switched timeslot being converted to a packet switched timeslot at the instigation of a new DTM service shortly after determination of the previous service. At the same time, it can be ensured that if the packet switched time slot resource is more needed in other cells, the time slot will be converted back thereby releasing the resource. Thus, a combined resource restriction can be met while ensuring that resource is effectively distributed in the system.

It will be appreciated that although the above described example relates to a conversion of a circuit switched timeslot to a packet switched timeslot, the described principles apply equally well to a conversion from a packet switched timeslot to a circuit switched timeslot.

As a specific example, the cell congestion characteristic can be a circuit switched loading characteristic and/or a packet switched loading characteristic. For example, when the DTM service terminates, the timeslot configuration processor 115 can evaluate if the circuit switched loading in the serving cell is above a given level determined in response to a service type usage in the group of cells, and if so, a timeslot can be converted back to a circuit switched timeslot (or can be maintained as a circuit switched timeslot if the timeslot was originally a packet switched timeslot).

In some embodiments, the circuit switched loading can be compared to the packet switched loading in accordance with a suitable comparison criterion. If the comparison indicates that the loading in one domain is relatively higher than in the other domain, the timeslot can be configured for this domain. For example, if the timeslot is a circuit switched timeslot, which temporarily has been converted to a packet switched timeslot, it can only be converted back to a circuit switched timeslot if the circuit switched loading is higher than the packet switched loading.

As another example, the service type usage characteristic(s) can include a loading characteristic for DTM services. For example, in some embodiments, only a certain number of DTM services can be allowed per cell or per packet control unit. If the DTM service loading in a given cell is close to the maximum for that cell, it is unlikely that the requirement for resources to support DTM services will expand significantly. Accordingly, the timeslot can be converted back to the original form wherein it can be more suitable for supporting other services of the communication system.

As yet another example, the service type usage characteristic(s) can include a loading of a communication service which is not a sub-service of the combined service. Specifically, the loading of non-DTM services can be taken into account. As a specific example, if there is currently a high loading of circuit switched services which are not DTM services, the PS-to-CS conversion processor 207 can convert the packet switched timeslot back to the circuit switched domain regardless of the DTM loading in order to ensure that sufficient resource is available for other circuit switched services.

Specifically, the timeslot configuration processor 115 can take into account the admittance of other services such as group call services.

It will be appreciated, that the specific embodiments described provide for improved performance. In particular, the timeslot configuration to support either the circuit switched or packet switched domains can be managed according to the experienced congestion, whether this is cell or system wide. In addition, in the specific case of DTM services, the probability of having to reallocate a user if a secondary service request is received shortly after an initial service has completed is reduced. This furthermore decreases the number of timeslot conversions, and thus the intra cell handovers and the amount of time resources are out of service.

In the above examples, the conversion of a timeslot from one domain to another domain was instigated when a new DTM service was set up. Furthermore, when the DTM service terminates, it is evaluated if the timeslot should be converted back to the original domain. This evaluation furthermore considers the service type usage characteristics.

In some embodiments, a number of services or remote terminals may simultaneously use one timeslot. For example, for DTM services, a plurality of DTM services for different mobile terminals can use the same packet switched timeslot. In such embodiments, the evaluation of whether a conversion back to the original domain should be initiated can be performed in response to a determination that there are no DTM services currently using the packet switched timeslot.

It will be appreciated that although the above description focused on packet switched/circuit switched time slot conversions in connection with DTM services, the described principles apply to many other systems.

For example, the principles can equally apply to managing co-existence between DTM services, MBMS services and/or GPRS services. For example, one resource controller can control a packet switched data service type whereas another controls a packet switched voice service type. Conversions between time slot configurations for packet switched voice and data services can be controlled in response to the local and global usage characteristics for these services. For example, a voice time slot can be converted to a data time slot and only converted back if the local usage characteristic indicates that it is unlikely that a data time slot is required following the service termination, or if the global usage characteristics indicates that it is likely that the resource for a data time slot is needed in another cell.

Similarly, packet switched time slots configured for broadcasts can be converted to or from packet switched data or voice time slots with the return conversion being dependent on local and global usage characteristics.

It will also be appreciated that these principles apply equally well to management of time slots for circuit switched data and voice.

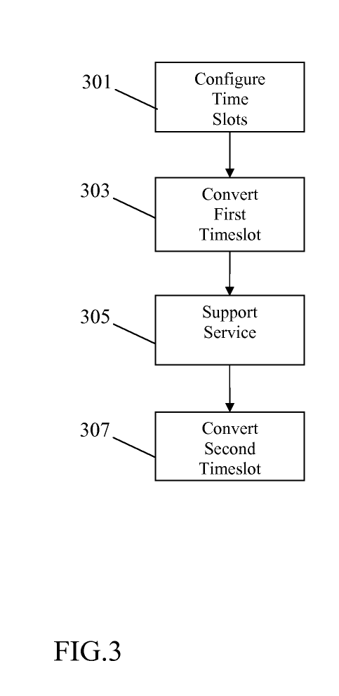

FIG. 3 illustrates an exemplary method of operation for the cellular communication system of FIG. 1.

The method initiates in step 301 wherein timeslots of the time frames are configured as a first service type or a second service type. Specifically, the timeslots can be configured as circuit switched timeslots or packet switched timeslot.

Step 301 is followed by step 303 wherein a first timeslot is converted from the first service type to the second service type. Specifically, a circuit switched timeslot can temporarily be converted to a packet switched timeslot in order to support a DTM service (or vice versa).

Step 303 is followed by step 305 wherein at least one service of the second service type is supported in the first timeslot. Specifically, the DTM service can be supported by the cellular communication system using the first timeslot as a packet switched timeslot to support the packet switched communication of the DTM service.

Step 305 is followed by step 307 wherein a conversion of the first timeslot from the second type to the first type is evaluated in response to a first service type usage characteristic for a cell supporting the at least one service and a second service type usage characteristic for a plurality of cells. Specifically, the conversion can only be made subject to the service type characteristics meeting a given criterion. Otherwise, no conversion can be made, and the first timeslot can be maintained as a timeslot of the second type.

It will be appreciated that the above description for clarity has described embodiments of the invention with reference to different functional units and processors. However, it will be apparent that any suitable distribution of functionality between different functional units or processors can be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention can optionally be implemented at least partly as computer software running on one or more data processors and/or digital signal processors. The elements and components of an embodiment of the invention can be physically, functionally and logically implemented in any suitable way. Indeed the functionality can be implemented in a single unit, in a plurality of units or as part of other functional units. As such, the invention can be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. An apparatus for a cellular communication system employing an air interface time frame structure comprising time frames divided into a plurality of timeslots; the apparatus comprising:
means for configuring timeslots of the time frames as a first service type or a second service type;
first conversion means for converting a first timeslot from the first service type to the second service type;
means for supporting at least one service of the second service type in the first timeslot; and
second conversion means for converting the first timeslot from the second type to the first type in response to a first service type usage characteristic for a cell supporting the at least one service and a second service type usage characteristic for a plurality of cells.

2. The apparatus of claim 1 wherein the first service type and the second service type are different service types from the group consisting of a packet switched service type and a circuit switched type.

3. The apparatus of claim 2 wherein one of the first service type usage characteristic and the second service type usage characteristic comprises a packet switched service loading characteristic, and the other service type usage characteristic comprises a circuit switched service loading characteristic.

4. The apparatus of claim 2 wherein one of the first service type usage characteristic and the second service type usage characteristic comprises a congestion characteristic for a serving cell for the at least one service, and the other service type usage characteristic comprises a congestion characteristic for a plurality of cells for the at least one service.

5. The apparatus of claim 1 wherein the plurality of cells consists in a group of cells associated with a timeslot allocator used for allocation of timeslots for the at least one service.

6. The apparatus of claim 1 wherein the cellular communication system is arranged to support a combined service comprising a first sub-service utilizing a timeslot of the first service type and a second sub-service utilizing a timeslot of the second service type and wherein the at least one service is the second sub-service.

7. The apparatus of claim 6 wherein at least one of the first service type usage characteristic and the second service type usage characteristic comprises a loading of a communication service not being a sub-service of the combined service.

8. The apparatus of claim 1 wherein the group of cells have a common resource restriction.

9. The apparatus of claim 1 wherein the second conversion means is arranged to convert the first timeslot from the second type to the first type if the first service type usage characteristic and the second service type usage characteristic meet a criterion and not to convert the first timeslot otherwise.

10. A method of operation in a cellular communication system employing an air interface time frame structure comprising time frames divided into a plurality of timeslots; the method comprising:
configuring timeslots of the time frames as a first service type or a second service type;
converting a first timeslot from the first service type to the second service type;
supporting at least one service of the second service type in the first timeslot; and
converting the first timeslot from the second type to the first type in response to a first service type usage characteristic for a cell supporting the at least one service and a second service type usage characteristic for a plurality of cells.
